(19) United States
(12) Patent Application Publication
(10) Pub. No.: US 2006/0235850 A1
(43) Pub. Date: Oct. 19, 2006

(54) Method and system for access authorization involving group membership across a distributed directory

(76) Inventors: Kristin M. Hazelwood, Austin, TX (US); Karla Kay Arndt, Rochester, MN (US); Mike Gong, Round Rock, TX (US); Richard A. Heller, Austin, TX (US); John Ryan McGarvey, Apex, NC (US)

Correspondence Address: IBM CORP (JRB);C/O LAW OFFICE OF JOSEPH R BURWELL, P O BOX 28022, AUSTIN, TX, 78755-8022, US

(21) Appl. No.: 11/105,613

(22) Filed: Apr. 14, 2005

(51) Int. Cl. G06F 17/30

(52) U.S. Cl. 707/9

(57) ABSTRACT

A system is presented for performing a directory operation within a distributed directory environment that includes distributed directory servers and a proxy server that acts as an intermediate agent between a client and the distributed directory environment. The proxy server sends requests to directory servers to collect information about group memberships for a user with respect to group entries within each portion of a distributed directory that is supported by each directory server. The proxy server sends the compiled information of group memberships for the user along with any directory operation that the proxy server requests on behalf of the user. A directory server receives the compiled information of group memberships along with a requested directory operation and then performs the requested directory operation with respect to its locally stored portion of the distributed directory information tree and with respect to the received information of group memberships for the user.

### BACKGROUND OF THE INVENTION

1. Field of the Invention

The present invention relates to an improved data processing system and, in particular, to a method and apparatus for database accessing; more specifically, the present invention is directed to a method and apparatus for performing an authentication operation in view of information from a distributed directory.

2. Description of Related Art

A directory is a special type of database for managing information about people, organizations, data processing systems, and other information sources. Information within a directory is organized within a hierarchical namespace. Each entry is a named object and consists of a set of attributes. Each attribute has a defined attribute type and one or more values. Each entry is identified by an unambiguous distinguished name (DN), wherein a distinguished name is a concatenation of selected attributes from an entry. A directory service provides a mechanism for searching a directory and for retrieving information from a directory. Various standards have been promulgated for defining directories and directory services. For example, the X.500 specifications define a directory standard; more information can be found in Weider et al., “Technical Overview of Directory Services Using the X.500 Protocol”, Internet Engineering Task Force (IETF) RFC 1309, March 1992. As another example, the Lightweight Directory Access Protocol (LDAP) specifications define a protocol for accessing a directory that supports the X.500 directory model; more information can be found in Wahl et al., “Lightweight Directory Access Protocol (v3)”, IETF RFC 2251, December 1997.

A logical representation of a directory does not necessarily reflect an organization of the physical storage of the directory. In a manner similar to many types of memory systems, a directory may be logically supported as a cohesive whole yet physically supported in a distributed manner. For example, a single directory may be stored across many servers, wherein each server supports a subtree of the directory.

An example of the usage of a directory may be a directory that stores information about individuals, e.g., employees of an enterprise, wherein each individual is one of many users of a distributed data processing system. An entry in a directory may store attributes about an individual; a specific user's entry within the directory would be identified by the user's distinguished name. Moreover, a group may be defined such that the group refers to a collection of users; an entry in the directory may contain information about group membership. An entry in the directory may store attributes about the group; a specific group's entry within the directory would be identified by the group's distinguished name. The term “user entry” may refer to an entry in a directory that represents storage of attributes for a specific user, and the term “group entry” may refer to an entry in a directory that represents storage of attributes for a specific group.

Various information processing issues may arise when employing a distributed storage mechanism for a directory that contains user entries and group entries. For example, a particular type of operation that is being performed on behalf of a specified user with respect to a specified target object may require a positive determination of membership within a specific group for the specified user as a requirement for successful completion of the particular type of operation. Although a specified user may belong to the specific group, i.e. the specified user may possess the required group membership, determining that fact may be problematic when employing a distributed directory. In some cases, the user entry for the specified user may reside within a portion of the distributed directory that is supported by a different server than another portion of the distributed directory that contains the group entry for the group to which the specified user belongs. Hence, when a server attempts to perform an operation for a specified user, it may be trivial to retrieve a user entry from a locally stored and locally supported portion of a distributed directory; however, it may be difficult to retrieve the necessary group entry because the server may not have readily available either information or a mechanism to locate and/or retrieve the group entry that is stored elsewhere within the distributed directory. In other words, if a user entry for the specified user resides on one server and a group entry for the group which has the user as a member resides on a different server, the obstacle of distributed storage must be overcome in order to determine that the specified user belongs to the group.

A more specific and difficult problem is the act of determining group membership that is required for access control across a distributed directory. For example, with respect to a directory, users can be a member of one or more groups, yet the group membership is used to determine access to entries within that directory. In other words, only members of certain groups should be provided access to certain portions of the directory in which the users and the users' groups are defined. In current directory server implementations, it is not difficult to restrict access because it is assumed that the user and the user's groups reside on the same directory server. There is a need, though, in typical distributed data processing environments to support distributed directory systems in which a distributed directory system provides a single directory information tree (DIT) that is divided and supported among multiple directory servers; clients should be able to transparently access the distributed directory servers, thereby automatically and seamlessly retrieving information from the directory information tree without having to know details about how the data is split among the supporting servers. To this end, some current systems have employed proxy servers that assist in accessing a directory information tree that is supported over multiple servers.

However, two main problems exist when evaluating group membership to determine access in a distributed directory environment. First, group membership evaluation is difficult because user entries, group entries, and the target object entry can exist on any server that is supporting the distributed directory. Second, after group membership has been determined by a specific server for a given user, there is a need to communicate the information about that group membership from that specific server to the other servers that are supporting the distributed directory in order to support operations on behalf of the given user with respect to accessing information within the distributed directory, which may be supported and stored on any of those other servers.

One solution for avoiding the problem in which user entries, group entries, and target object entries reside in different portions of a distributed directory that are supported on different systems is as follows. Typically, an access control list (ACL) is employed to restrict access to a portion of a directory to specific users and groups, and the access control list refers to these specific user and groups; hence, processing the access control list requires retrieving user entries and group entries from the directory. Therefore, one current solution requires that the computing environment ensures that information about all users and groups to which an ACL refers also resides locally within the portion of the directory that is supported by the server that evaluates an ACL. This can be done by replicating all user entries and all group entries to all of the servers that are supporting the distributed directory. However, this task becomes cumbersome because the entries for the target objects are often in the same subtree as the user entries and the group entries. Replicating all the user entries and group entries also requires replicating all of the entries in the respective subtree of a user entry or a group entry, thereby defeating the purpose of a distributed directory.

A different solution would be to define a set of users and groups for each distributed directory server. However, this solution is fragile and not flexible. The users and groups would have to be defined in a different subtree than the data. Users would also only have access to one server's data. Therefore, this solution would violate the requirement that the distributed directory environment should support the partitioned data in a way that appears seamless to the end user.

Yet other solutions would be for an administrator to manually determine group membership for a given user or for an application to employ its own algorithm to specifically determine group membership for a given user. However, after the group membership is determined, there is no way to communicate this information with the directory servers. Moreover, the determination of group membership would be error-prone, and it would be a duplication of effort; the directory servers already have algorithms for determining group membership.

Therefore, it would be advantageous to provide a method for evaluating group membership for a given user in order to determine access in a distributed directory environment such that a distributed directory is supported without an additional requirement of replication of data or without an additional requirement that restricts the storage location of portions of a distributed directory.

### SUMMARY OF THE INVENTION

A method, system, apparatus, or computer program product is presented for performing a directory operation within a distributed directory environment that includes one or more distributed directory servers and a proxy server that acts as an intermediate agent between a client and the distributed directory environment. The proxy server sends requests to directory servers to collect or compile information about group memberships for a user with respect to group entries within each portion of a distributed directory that is supported by each directory server. The proxy server then sends the compiled information of group memberships for the user along with any directory operation that the proxy server sends to a directory server on behalf of the user. A directory server receives and accepts the compiled information of group memberships along with a requested directory operation and then performs the requested directory operation with respect to its locally stored portion of the distributed directory information tree and with respect to the received information of group memberships for the user.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIG. 1C depicts a block diagram that shows a typical distributed data processing system for an enterprise domain;

FIG. 2A depicts a block diagram that shows a typical distributed directory environment;

FIG. 2B depicts a block diagram depicts a distributed directory environment that has been enhanced to include functionality for supporting directory access authorization in view of group membership in accordance with an embodiment of the present invention;

FIG. 3A depicts a block diagram that shows a typical dataflow between a client or a client application and a directory proxy server;

FIG. 3B depicts a block diagram that shows a dataflow between a directory proxy server and a directory server to obtain information about group memberships for a given user in accordance with an embodiment of the present invention;

FIG. 3C depicts a block diagram that shows a dataflow between a directory proxy server and a directory server to perform a directory operation with respect to an identified user or client and its associated group memberships in accordance with an embodiment of the present invention;

FIG. 4 depicts a flowchart that shows a process at a proxy server for compiling a set of group memberships with respect to a given user for subsequent use during directory operations for the given user within a distributed directory environment in accordance with an embodiment of the present invention;

FIG. 5 depicts a flowchart that shows a process at a proxy server for performing a requested directory operation while employing a set of group memberships with respect to a given user within a distributed directory environment in accordance with an embodiment of the present invention; and

FIG. 6 depicts a flowchart that shows a process at a directory server for performing a requested directory operation while employing a set of group memberships that have been provided by a directory proxy server with respect to a given user within a distributed directory environment in accordance with an embodiment of the present invention.

### DETAILED DESCRIPTION OF THE INVENTION

In general, the devices that may comprise or relate to the present invention include a wide variety of data processing technology. Therefore, as background, a typical organization of hardware and software components within a distributed data processing system is described prior to describing the present invention in more detail.

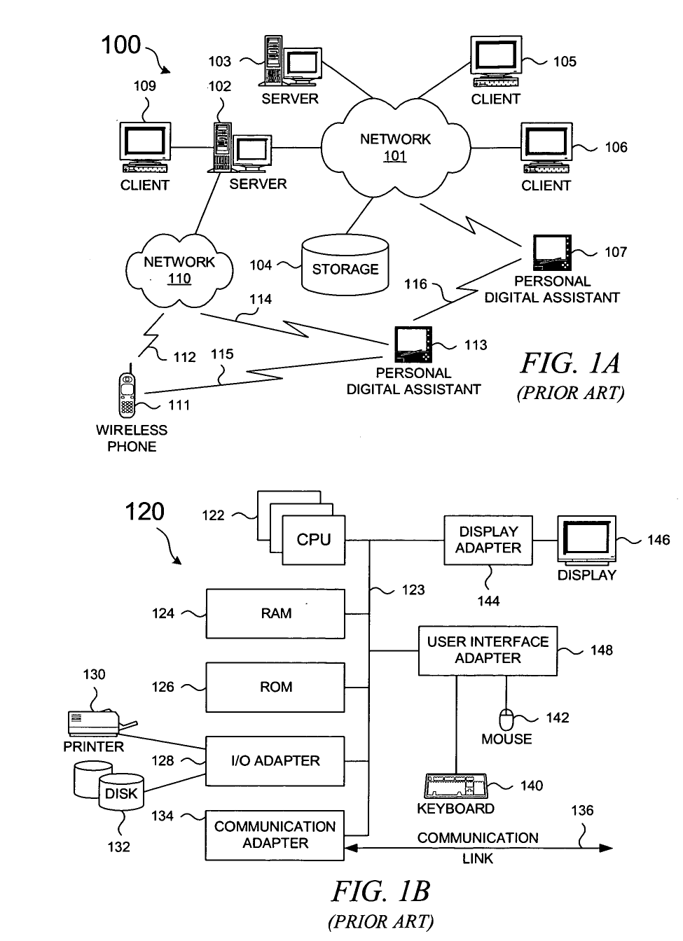

With reference now to the figures, FIG. 1A depicts a typical network of data processing systems, each of which may implement a portion of the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), File Transfer Protocol (FTP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as an audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files.

The present invention may be implemented on a variety of hardware and software platforms, as described above with respect to FIG. 1A and FIG. 1B. More specifically, though, the present invention is directed to an improved distributed data processing environment. Prior to describing the present invention in more detail, some aspects of typical distributed data processing environments are described.

The descriptions of the figures herein may involve certain actions by either a client device or a user of the client device. One of ordinary skill in the art would understand that responses and/or requests to/from the client are sometimes initiated by a user and at other times are initiated automatically by a client, often on behalf of a user of the client. Hence, when a client or a user of a client is mentioned in the description of the figures, it should be understood that the terms “client” and “user” can be used interchangeably without significantly affecting the meaning of the described processes.

Certain computational tasks may be described hereinbelow as being performed by functional units. A functional unit may be represented by a routine, a subroutine, a process, a subprocess, a procedure, a function, a method, an object-oriented object, a software module, an applet, a plug-in, an Active™ control, a script, or some other component of firmware or software for performing a computational task.

The descriptions of the figures herein may involve an exchange of information between various components, and the exchange of information may be described as being implemented via an exchange of messages, e.g., a request message followed by a response message. It should be noted that an exchange of information between computational components, which may include a synchronous or asynchronous request/response exchange, may be implemented equivalently via a variety of data exchange mechanisms, such as messages, method calls, remote procedure calls, event signaling, or other mechanism.

The present invention is described hereinbelow with respect to terminology and functionality as associated with X.500 directories and Lightweight Directory Access Protocol (LDAP) operations, but it should be noted that the present invention may be implemented using a variety of directory implementation schemes and protocols.

With reference now to FIG. 1C, a block diagram depicts a typical distributed data processing system for an enterprise domain. As in a typical corporate computing environment or an Internet-based computing environment, enterprise domain 150 hosts controlled resources that user 151 can access, e.g., by using browser application 152 on client device 153 through network 154.

Enterprise domain 150 supports multiple servers. Application servers 155 support accessible resources through web-based applications or other types of applications, including legacy applications. Authentication servers 156 support various authentication mechanisms, such as username/password, X.509 certificates, secure tokens, or an SSL session.

Proxy server 157 performs a wide range of functions for enterprise domain 150. Proxy server 157 can be administratively configured through configuration files and enterprise policy database 158 to control the functionality of proxy server 157, e.g., caching web pages in order to mirror the content from an application server or filtering the incoming and outgoing datastreams through input datastream filter unit 159 and output datastream filter unit 160. Input datastream filter unit 159 may perform multiple checks on incoming requests while output datastream filter unit 160 may perform multiple checks on outgoing responses; each check may be performed in accordance with goals and conditions that are specified within various enterprise policies.

Enterprise domain 150 comprises entitlements server 161, which accepts information within user registry database 162, access control list (ACL) database 163, and third-party datastreams 164 from other domains. Entitlements server 161 determines whether users are authorized to access certain services that are provided by application servers 155 within domain 150 by checking policies and/or access control lists against user requests for those services. A set of user-specific entitlements is used by proxy server 157, entitlement server 161, or a combined or coordinated effort between proxy server 157 and entitlement server 161 to determine or control access to application servers 155 and other controlled resources in response to user requests.

The above-noted entities within enterprise domain 150 represent typical entities within many computing environments. Web-based applications can utilize various means to prompt users to enter authentication information, often as a username/password combination within an HTML form. In the example that is shown in FIG. 1C, user 151 may be required to be authenticated before client 153 may have access to resources, after which a session is established for client 153. In FIG. 1C, after receiving an incoming request from client 153, input datastream filter unit 159 may determine whether client 153 has already established a session; if not, an authentication service on authentication servers 156 can be invoked in order to authenticate user 151. If client 153 has already established a session, then additional checks may be performed on an incoming request prior to granting access to a controlled resource; the additional checks may be specified in an enterprise authentication policy.

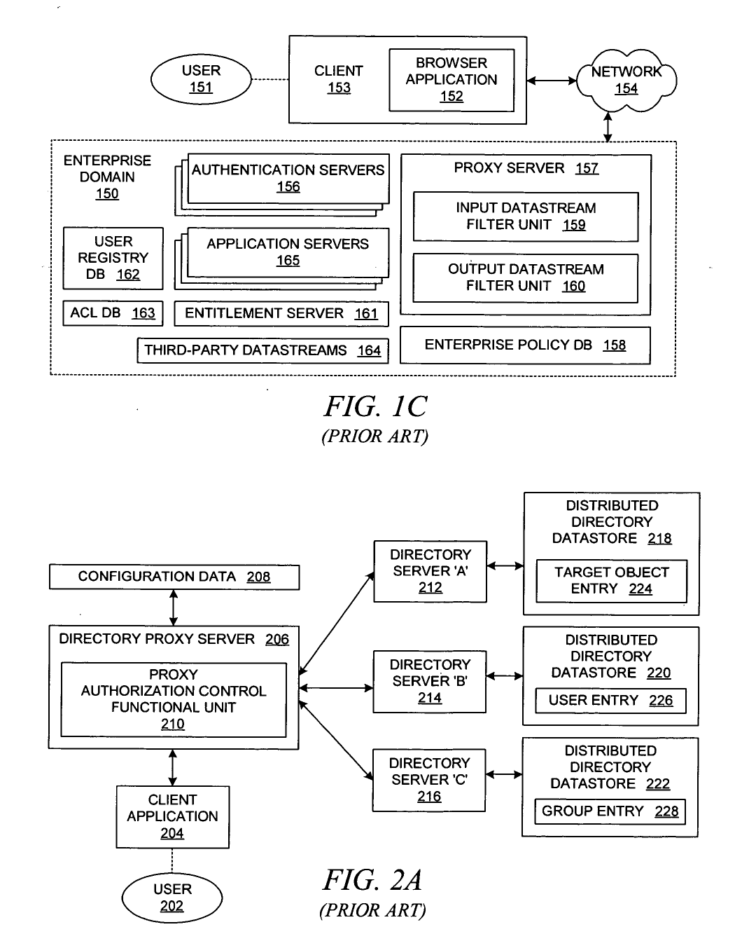

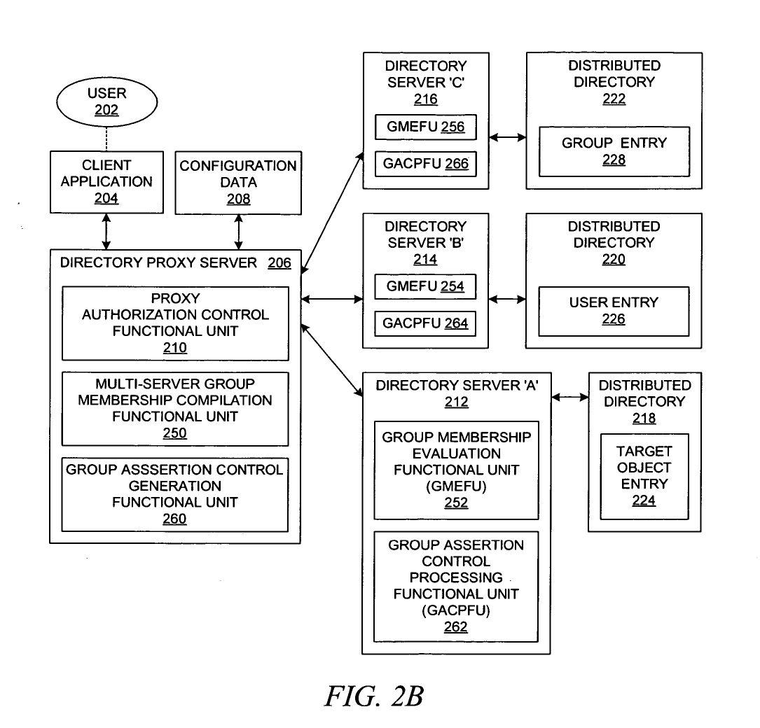

With reference now to FIG. 2A, a block diagram depicts a typical distributed directory environment. User 202 operates client application 204, which may execute on a client device such as client 153 as shown in FIG. 1C. Client application 204 interacts with directory servers through a proxied directory server, also known as a directory proxy server or a proxy directory server, which is shown as proxy server 206; proxy server 206 may execute on the user's client device or elsewhere within a network of connected devices, such as those shown in FIG. 1A. Proxy server 206 may be associated with configuration files 208 that contain information that is managed via an administrative user application to control the functionality of proxy server 206.

Proxy server 206 acts as an intermediate agent to the distributed directory environment. Proxy server 206 is able to perform operations in accordance with a variety of directory schemes and protocols, including LDAP specifications. Proxy server 206 contains proxy authorization control functional unit 210, which generates proxy authorization controls, also called proxied authorization controls, that are employed by proxy server 206 to perform an operation with respect to the distributed directory on behalf of client application 204, or equivalently, on behalf of user 202. As described in Wahl et al., “Lightweight Directory Access Protocol (v3)”, IETF RFC 2251, December 1997, a control is a way to specify extension information for use with an LDAP operation. Controls can be sent as part of an LDAP request and apply only to the accompanying request. If the server recognizes the control type and it is appropriate for the operation, the server will make use of the control when performing the requested operation; various optional parameters can be used to inform the server whether or not to ignore the control if it is unrecognized or it is inappropriate. The control also contains an object identifier that has been assigned to the control.

Hence, proxy authorization control functional unit 210 can present an application programming interface (API) that accepts a proxy distinguished name (DN) as an input parameter; this input parameter specifies the DN of the entry of the identity that proxy server 206 is to assume when performing an operation on behalf of client application 204 or user 202. The provided API can be used by the caller to create an LDAP control containing the proxy authorization identity; the created proxy authorization control would then be included in LDAP operations to request an operation from a directory server. Using the proxy authorization control mechanism, a client, or in this case, proxy server 206, can bind to the directory engine using its own identity, but is granted proxy authorization rights of another user, i.e. user 202 or client application 204, to access the target directory. When the LDAP server receives an operation with proxy authorization control, the bind DN is validated against the administrative group and/or the predefined proxy authorization group to determine whether the bind DN should be granted the proxy authorization right. In other words, the bound application client, which is proxy server 206 in this example, must be a member of the administrative group or proxy authorization group in order to request a proxy authorization operation. More information about using a proxy authorization control can be found in Weltman, “LDAP Proxied Authorization Control”, IETF Internet-Draft, draft-weltman-1dapv3-proxy-12.txt, April 2003. The LDAP protocol also supports an extension mechanism that allows additional operations to be defined for services that are not defined within the LDAP specification. An extended operation allows clients to make requests and receives responses with predefined syntaxes and semantics that may be specific to particular implementations.

The distributed directory environment includes multiple directory servers 212-216 that interoperate within the same distributed data processing environment as proxy server 206 and client application 204, e.g., in a manner similar to the distributed data processing environments that are shown in FIG. 1A and FIG. 1C. Directory servers 212-216 support functionality for accessing datastores that contain portions of a distributed directory, i.e. portions of a directory information tree, shown as distributed directory datastores 218-222. Directory servers 212-216 also contain functionality, which is not shown in FIG. 2A, that supports the receipt and processing of proxied authorization controls, e.g., as may be sent by proxy server 206 or other directory clients.

In a manner similar to the scenario that was described further above, user entries, group entries, and target object entries that are of interest to a particular directory operation may reside in different portions of a distributed directory that are supported on different systems. In the example that is shown in FIG. 2A: target object entry 224 resides within distributed directory datastore 218; user entry 226 resides within distributed directory datastore 220; and group entry 228 resides within distributed directory datastore 222.

With reference now to FIG. 2B, a block diagram depicts a distributed directory environment that has been enhanced to include functionality for supporting directory access authorization in view of group membership in accordance with an embodiment of the present invention. FIG. 2B is similar to FIG. 2A, wherein similar reference numerals refer to similar elements; however, in contrast to FIG. 2A, FIG. 2B illustrates additional functionality to support an embodiment of the present invention.

FIG. 2B illustrates an exemplary embodiment that contains two mechanisms that enhance a distributed directory environment in accordance with the present invention. The first mechanism consists of functionality to support requests to directory servers within the distributed directory environment to evaluate group membership when given a user's distinguished name and a set of attributes. This mechanism allows for group membership evaluation without the user's entry residing on the same server. For example, if an application is performing an operation on behalf of a user, this mechanism can be used to determine the groups in a distributed directory to which a user belongs.

The second mechanism consists of functionality to support requests for a directory server to perform directory operations while accepting an assertion that the specified user belongs to a set of groups as indicated within information about the user's group memberships that is provided along with a request for the directory operation. For example, once it has been determined that a user belongs to a set of groups, information about these groups, such as the distinguished names of the groups and the attributes for the groups, can be sent on all subsequent requests for directory operations on behalf of the user, thereby giving to the user the same effective authorized access as if all of the necessary information for determining authorized access resided locally. In other words, the user subsequently has the same access as the user would have if all of the necessary group entries were stored on the same directory server.

FIG. 2B illustrates an exemplary embodiment in which these two mechanisms are represented by functional units within a proxy directory server and within one or more directory servers. The first mechanism is supported by multi-server group membership compilation functional unit 250 on proxy server 206 along with corresponding components on the directory servers: group membership evaluation functional unit (GMEFU) 252 on directory server 212, GMEFU 254 on directory server 214, and GMEFU 256 on directory server 216. The first mechanism employs a novel extended directory operation that can be used by the proxy server to determine and evaluate group membership for a given user. When a directory server receives the extended operation from the proxy server, the directory server accesses its back-end datastore and determines group membership; further detail for this mechanism is described hereinbelow with respect to the remaining figures.

The second mechanism is supported by group assertion control generation functional unit 260 on proxy server 206 along with corresponding components on the directory servers: group assertion control processing functional unit (GACPFU) 262 on directory server 212, GCAPFU 264 on directory server 214, and GCAPFU 266 on directory server 216. The second mechanism employs a novel control, herein termed a group assertion control, that can be used by the proxy server in association with any directory operation; in a preferred embodiment, the group assertion control may be formatted and processed in accordance with LDAP controls. When a directory server receives a group assertion control from the proxy server along with a directory operation, the directory server assumes that the identified user, i.e. the identity for which the directory operation is being performed, belongs to a set of identified groups, i.e. the set of groups as specified within the group assertion control; it may be assumed that the directory server accepts the group assertion control based on an implicit or explicit trust relationship between the directory server and the proxy server within the distributed directory environment. After receiving the group assertion control, the directory server performs all authorization determinations for accessing the distributed directory based on the asserted set of groups. The group assertion control can be employed along with a proxy authorization control such that the group assertion control and the proxy authorization control are employed in association with the same directory operation; when the two controls are employed with respect to the same directory operation, the directory server performs the requested directory operation on behalf of a provided user identity in view of the identified user's set of group memberships. Further detail for this mechanism is described hereinbelow with respect to the remaining figures.

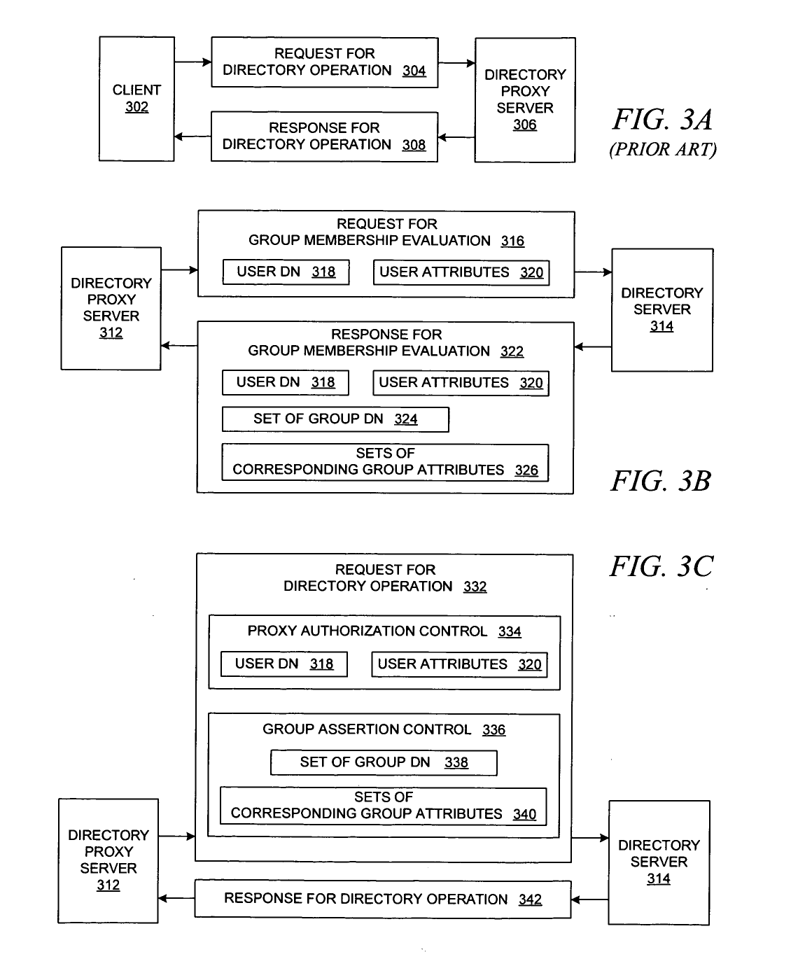

With reference now to FIG. 3A, a block diagram depicts a typical dataflow between a client or a client application and a directory proxy server. Client 302 sends request message 304 that represents a request for a directory operation to proxy server 306. After performing the requested directory operation, proxy server 306 returns response message 308 that represents a response for the requested directory operation to client 302. Client 302 then performs some additional computation task on the information that it has received. In this manner, the exchange of a request and response with respect to a directory operation between a client and a directory proxy server is similar to a dataflow that would be found within a typical distributed directory environment. It may be assumed that proxy server 306 obtains or has previously cached a user identity and any necessary authentication credentials for performing an authentication operation (not shown) for the user or the client for which the directory operation is being performed.

With reference now to FIG. 3B, a block diagram depicts a dataflow between a directory proxy server and a directory server to obtain information about group memberships for a given user in accordance with an embodiment of the present invention. Proxy server 312 sends request message 316 to directory server 314; request message 316 represents a request for directory server 314 to determine the groups to which an identified user belong with respect to the information that is stored within the portion of the directory information tree that is supported by directory server 314. Request message 316 contains user DN 318 for identifying a specific user and also contains user attributes 320 for the specific user for performing the group membership determinations in view of the group entries that reside locally in a datastore that is supported by directory server 314. After directory server 314 has determined the appropriate set of group memberships for the identified user, directory server 314 returns to proxy server 312 response message 322 that represents the response for the group evaluation determination for the previously specified user. Response message 322 contains a set of group DN's 324 and preferably also contains a set of corresponding group attributes 326 for the accompanying group DN's; response message 322 may also echo user DN 318 and user attributes 320. It may be assumed that messages within the distributed directory environment are cryptographically protected as necessary.

In this manner, the proxy server and the directory server can exchange a request and a response to enable the proxy server to obtain a set of group memberships for the user as is known to a particular directory server, such as directory server 314. In a distributed directory environment, though, directory server 314 would be one of a plurality of directory servers that support a directory information tree that is split among many physically datastores, e.g., as shown in FIG. 2B that depicts multiple directory servers. Hence, as illustrated in more detail further below, the proxy server sends a group membership evaluation request to each directory server within the distributed directory environment in order to determine all of a given user's group memberships, which may be reflected in group entries that are spread throughout the datastores that contain the distributed directory.

With reference now to FIG. 3C, a block diagram depicts a dataflow between a directory proxy server and a directory server to perform a directory operation with respect to an identified user or client and its associated group memberships in accordance with an embodiment of the present invention. Similar reference numerals in FIG. 3B and FIG. 3C refer to similar elements. Proxy server 312 sends request message 332 to directory server 314; request message 332 represents a request for directory server 314 to perform a directory operation with respect to information that is provided about an identified user.

It should be noted that request message 332 that is used to request a directory operation as shown in FIG. 3C is not identical to request message 304 that is used to request a directory operation as shown in FIG. 3A; request message 304 has been modified, copied and modified, or generated to include copied information from request message 304. Hence, request message 332 contains any necessary information from request message 304 for performing the originally requested directory operation. In addition, request message 332 contains proxy authorization control 334 that includes user DN 318 for identifying a specific user and also includes user attributes 320 for the specific user; the acceptance of proxy authorization control 334 by directory server 314 allows proxy server 312 to act as a proxy agent for a client, e.g., client 302 in FIG. 3A. In other words, proxy authorization control 334 informs the receiving directory server, e.g., directory server 314, that proxy server 312 is authorized to request the directory operation that is represented by request message 332 as if directory server 314 had received request message 332 directly from client 302.

In accordance with the novel capabilities of the present invention, request message 332 also contains group assertion control 336. As described above, proxy server 312 has previously gathered information about the identified user's group memberships, e.g., by using the request/response exchange as described above with respect to FIG. 3B. Proxy server 312 now asserts this accumulated group membership information during a directory operation by sending group assertion control 336 along with the request for the directory operation. Group assertion control 336 contains a set of group DN's 338 and preferably also contains a set of corresponding group attributes 340 for the accompanying group DN's; group assertion control may also contain any other appropriate information, such as an object ID (OID). In some cases, the set of group DN's and group attributes in request message 332 may be identical to the set of group DN's and group attributes in response message 322 in FIG. 3B. More likely, though, they are not identical because the group membership information in group assertion control 336 includes zero or more group DN's that have been retrieved from one or more directory servers, including directory server 314.

After performing the requested directory operation, directory server 314 sends response message 342 to proxy server 312; response message 342 contains the results of the directory operation, which may include failure information. Proxy server 312 processes response message 342 and returns a response message to the requesting client, e.g., as shown in FIG. 3A.

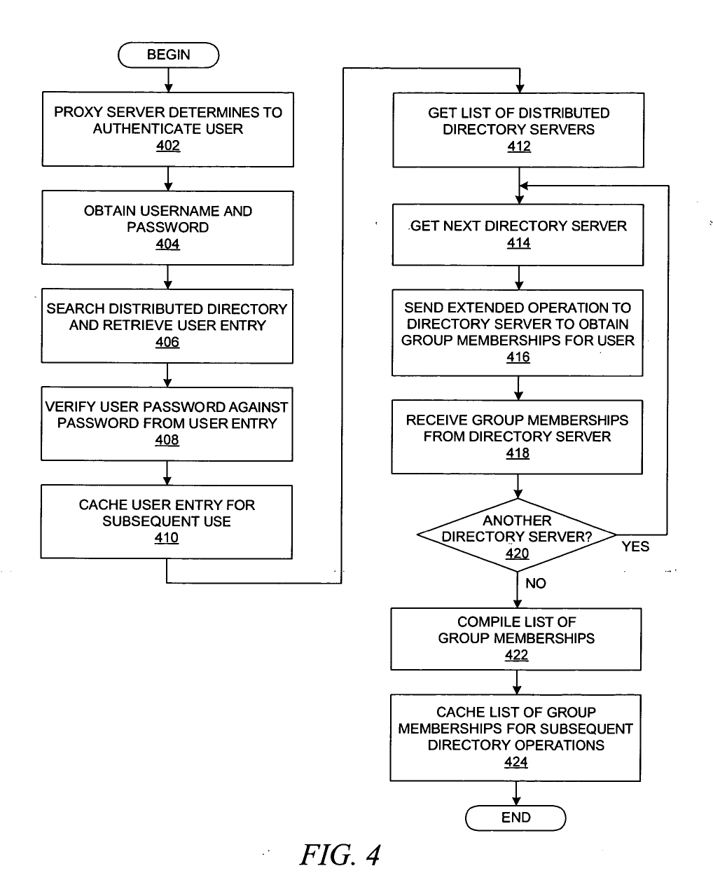

With reference now to FIG. 4, a flowchart depicts a process at a proxy server for compiling a set of group memberships with respect to a given user for subsequent use during directory operations for the given user within a distributed directory environment in accordance with an embodiment of the present invention. The process commences when a directory proxy server determines to perform an authentication operation with respect to a given user (step 402); this determination would be triggered by previous events that are not shown within FIG. 4, and this process may conclude with additional steps that are not shown in FIG. 4. For example, the proxy server may receive a request from a client application to login to the distributed directory environment. As another example, the proxy server may receive a request for an initial directory operation, but after determining that the proxy server does not yet have authentication credentials for the requesting user, the proxy server determines to perform an authentication operation with respect to the user. The authentication operation in FIG. 4 depicts a username-password verification process, but alternative types of authentication operations may be performed, e.g., an authentication operation based on digital certificates.

The proxy server obtains a username and password combination for the user, e.g., by interaction with a client application (step 404). The proxy server searches the distributed directory to find and retrieve the proper user entry (step 406), and the previously obtained user password is verified against a user password that is stored within the user entry (step 408). If the password is not verified, some type of error is reported, and the process would be concluded; otherwise, assuming that the password is verified, the proxy server caches the user entry for subsequent use (step 410).

The authentication-related procedure that is shown in steps 402-410 is typically performed within many directory environments. However, FIG. 4 also depicts novel steps that are performed in accordance with an embodiment of the present invention.

The proxy server retrieves a list of distributed directory servers within its distributed directory environment (step 412); this list may be retrieved from any appropriate location, including a configuration file for the proxy server. The proxy server then proceeds through the list of directory servers and performs a series of steps with respect to each directory server in the list.

The proxy server retrieves information about the next directory server in the list (step 414); this directory server is considered to be the current directory server with respect to the proxy servers current actions. The retrieved information about the current directory server may include a variety of information: an identifier for the directory server; a protocol to be used to contact the directory server; an address to be used to contact the directory server; and any other information that might be used within a particular distributed directory environment to inform the proxy server how to perform various operations. The proxy server then sends an extended operation to the current directory server to obtain group memberships for the user (step 416); the extended operation would include the user DN and the user attributes for the user. At some point in time, the proxy server receives any group membership information from the current directory server (step 418); the group information includes a set of group DN's and a set of group attributes along with any other appropriate information.

The proxy server then checks whether or not there is another directory server in the list of directory servers (step 420), and if so, then the process loops back to step 414 to perform the retrieval of group membership information with respect to a different directory server. If there are no additional directory servers, then the proxy server compiles a list of group memberships for the user (step 422). The information about the group memberships is cached for subsequent directory operations in association with the user DN for the user (step 424), and the process is concluded.

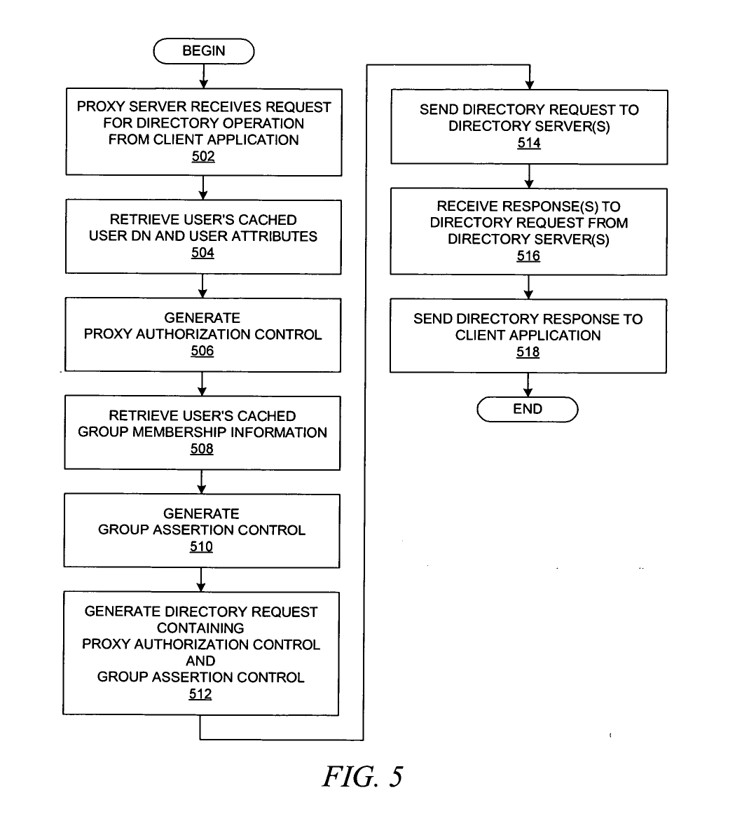

With reference now to FIG. 5, a flowchart depicts a process at a proxy server for performing a requested directory operation while employing a set of group memberships with respect to a given user within a distributed directory environment in accordance with an embodiment of the present invention. The process commences when a directory proxy server receives a request for a directory operation from a client application (step 502). If the distributed directory operation supports or requires secure operations, then it may be assumed that the proxy server has already authenticated the requesting client or its user; if not, an authentication operation may be performed after step 502, e.g., as shown in FIG. 4. The proxy server then retrieves a user DN and user attributes for the user on whose behalf the directory operation is being requested (step 504), and the proxy server generates a proxy authorization control (step 506) to be included within a directory request that the proxy server subsequently sends to a directory server.

The proxying-related procedure that is shown in steps 502-506 is typically performed within many directory environments. However, FIG. 5 also depicts novel steps that are performed in accordance with an embodiment of the present invention.

The proxy server retrieves previously cached group membership information for the user (step 508) and then generates a group assertion control that contains the user's group membership information (step 510). The proxy server creates a directory request that contains the generated proxy authorization control and the generated group assertion control (step 512), and the proxy server sends the directory request to one or more directory servers as necessary (step 514). At some subsequent point in time, the proxy server receives a directory response from one or more directory servers (step 516), e.g., as appropriate to its actions with respect to step 514. The proxy server then generates and sends a directory response to the requesting client application (step 518), and the process is concluded.

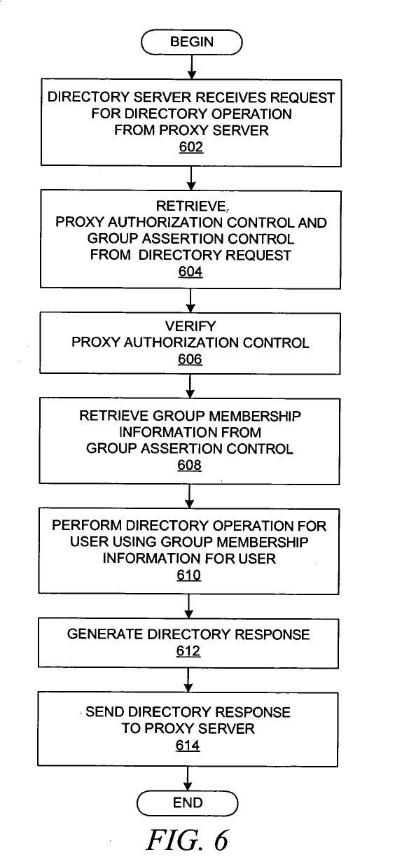

With reference now to FIG. 6, a flowchart depicts a process at a directory server for performing a requested directory operation while employing a set of group memberships that have been provided by a directory proxy server with respect to a given user within a distributed directory environment in accordance with an embodiment of the present invention. The process commences when the directory server receives a request for a directory operation from a directory proxy server (step 602). The directory server recognizes and retrieves a proxy authorization control and a group assertion control from the received directory operation request (step 604). The directory server then verifies the proxy authorization control in some manner (step 606). If the verification fails, then some type of error would be reported and/or returned; assuming that the proxy authorization control is verified, then the directory server performs its subsequent actions with respect to a user that is identified within the proxy authorization control.

The directory server then retrieves the group membership information from the group assertion control (step 608). The directory server performs the requested directory operation with respect to the group membership information on behalf of the identified user (step 610). Information for the results of the directory operation is stored within a generated directory response (step 612), and the directory response is sent to the requesting proxy server (step 614), thereby concluding the process.

The advantages of the present invention should be apparent in view of the detailed description that is provided above. When a directory server receives a group assertion control within a request for a directory operation, the group assertion control contains information about a given user's group memberships that have been previously evaluated. The directory server can then perform the requested directory operation using the information that is stored within its portion of a directory information tree and using the received group membership information, e.g., a set of group DN's and associated group attributes.

If the requested directory operation requires accessing a portion of the directory information tree for which access has been restricted to only users of a particular group, then the directory server has the ability to determine whether or not the user belongs to that particular group. Hence, the present invention provides a mechanism to support evaluation of group membership for a given user in order to determine access in a distributed directory environment such that a distributed directory is supported without an additional requirement of replication of data or without an additional requirement that restricts the storage location of portions of a distributed directory.

It is important to note that while the present invention has been described in the context of a fully functioning data processing system, those of ordinary skill in the art will appreciate that some of the processes associated with the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for performing a directory operation within a distributed directory environment, wherein the distributed directory environment includes one or more distributed directory servers and a proxy server that acts as an intermediate agent between a client and the distributed directory environment, the method comprising:
sending a first request from a proxy server to a directory server, wherein the first request indicates a user for which the directory server determines group memberships with respect to group entries within a portion of a distributed directory that is supported by the directory server;
receiving a first response at the proxy server from the directory server, wherein a first response contains a set of distinguished names and attributes for group entries that represent groups for which the user has group membership; and
storing at the proxy server the set of distinguished names and attributes for group entries that represent groups for which the user has group membership.

2. The method of claim 1 further comprising:
obtaining at the proxy server a set of distinguished names and attributes for group entries that represent groups for which the user has group membership by employing an extended operation within a directory access protocol to request and receive information from a directory server.

3. The method of claim 1 further comprising:
obtaining at the proxy server a set of distinguished names and attributes for group entries that represent groups for which the user has group membership from each directory server within the distributed directory environment.

4. The method of claim 1 further comprising:
generating, based on responses from multiple directory servers within the distributed directory environment, a compiled set of distinguished names and attributes for group entries that represent groups for which the user has group membership.

5. The method of claim 4 further comprising:
sending a second request from the proxy server to a directory server, wherein the second request indicates a directory operation to be performed on behalf of the user, and wherein the second request contains the compiled set of distinguished names and attributes for group entries that represent groups for which the user has group membership.

6. The method of claim 5 further comprising:
generating a control that contains the compiled set of distinguished names and attributes for group entries that represent groups for which the user has group membership, wherein the control is formatted in accordance with a directory access protocol; and
placing the generated control in the second request.

7. A method for performing a directory operation within a distributed directory environment, wherein the distributed directory environment includes one or more distributed directory servers and a proxy server that acts as an intermediate agent between a client and the distributed directory environment, the method comprising:
receiving a first request from a proxy server at a directory server within the distributed directory environment, wherein the first request contains a distinguished name and attributes for a user;
evaluating group membership for the user with respect to the distinguished name and attributes for the user and with respect to group entries in a directory information tree that is supported by the directory server; and
sending a first response from the directory server to the proxy server, wherein the first response contains a first set of distinguished names and attributes for group entries that represent groups for which the user has group membership.

8. The method of claim 7 further comprising:
receiving a second request from a proxy server at a directory server within the distributed directory environment, wherein the second request indicates a directory operation to be performed by the directory server, wherein the second request contains a second set of distinguished names and attributes for group entries that represent groups for which the user has group membership, and wherein the second request contains a distinguished name and attributes for the user.

9. The method of claim 8 further comprising:
performing the directory operation with respect to the directory information tree that is supported by the directory server, the distinguished name and attributes for the user, and the second set of distinguished names and attributes for group entries that represent groups for which the user has group membership; and
sending a second response from the directory server to the proxy server after performing the directory operation.

10. A computer program product on a computer readable medium for performing a directory operation within a distributed directory environment, wherein the distributed directory environment includes one or more distributed directory servers and a proxy server that acts as an intermediate agent between a client and the distributed directory environment, the computer program product comprising:
means for sending a first request from a proxy server to a directory server, wherein the first request indicates a user for which the directory server determines group memberships with respect to group entries within a portion of a distributed directory that is supported by the directory server;
means for receiving a first response at the proxy server from the directory server, wherein a first response contains a set of distinguished names and attributes for group entries that represent groups for which the user has group membership; and
means for storing at the proxy server the set of distinguished names and attributes for group entries that represent groups for which the user has group membership.

11. The computer program product of claim 10 further comprising:
means for obtaining at the proxy server a set of distinguished names and attributes for group entries that represent groups for which the user has group membership by employing an extended operation within a directory access protocol to request and receive information from a directory server.

12. The computer program product of claim 10 further comprising:
means for obtaining at the proxy server a set of distinguished names and attributes for group entries that represent groups for which the user has group membership from each directory server within the distributed directory environment.

13. The computer program product of claim 10 further comprising:
means for generating, based on responses from multiple directory servers within the distributed directory environment, a compiled set of distinguished names and attributes for group entries that represent groups for which the user has group membership.

14. The computer program product of claim 13 further comprising:
means for sending a second request from the proxy server to a directory server, wherein the second request indicates a directory operation to be performed on behalf of the user, and wherein the second request contains the compiled set of distinguished names and attributes for group entries that represent groups for which the user has group membership.

15. The computer program product of claim 14 further comprising:
means for generating a control that contains the compiled set of distinguished names and attributes for group entries that represent groups for which the user has group membership, wherein the control is formatted in accordance with a directory access protocol; and
means for placing the generated control in the second request.

16. A computer program product on a computer readable medium for performing a directory operation within a distributed directory environment, wherein the distributed directory environment includes one or more distributed directory servers and a proxy server that acts as an intermediate agent between a client and the distributed directory environment, the computer program product comprising:
means for receiving a first request from a proxy server at a directory server within the distributed directory environment, wherein the first request contains a distinguished name and attributes for a user;
means for evaluating group membership for the user with respect to the distinguished name and attributes for the user and with respect to group entries in a directory information tree that is supported by the directory server; and
means for sending a first response from the directory server to the proxy server, wherein the first response contains a first set of distinguished names and attributes for group entries that represent groups for which the user has group membership.

17. The computer program product of claim 16 further comprising:
means for receiving a second request from a proxy server at a directory server within the distributed directory environment, wherein the second request indicates a directory operation to be performed by the directory server, wherein the second request contains a second set of distinguished names and attributes for group entries that represent groups for which the user has group membership, and wherein the second request contains a distinguished name and attributes for the user.

18. The computer program product of claim 17 further comprising:
means for performing the directory operation with respect to the directory information tree that is supported by the directory server, the distinguished name and attributes for the user, and the second set of distinguished names and attributes for group entries that represent groups for which the user has group membership; and
means for sending a second response from the directory server to the proxy server after performing the directory operation.

19. An apparatus for performing a directory operation within a distributed directory environment, wherein the distributed directory environment includes one or more distributed directory servers and a proxy server that acts as an intermediate agent between a client and the distributed directory environment, the apparatus comprising:
means for sending a first request from a proxy server to a directory server, wherein the first request indicates a user for which the directory server determines group memberships with respect to group entries within a portion of a distributed directory that is supported by the directory server;
means for receiving a first response at the proxy server from the directory server, wherein a first response contains a set of distinguished names and attributes for group entries that represent groups for which the user has group membership; and
means for storing at the proxy server the set of distinguished names and attributes for group entries that represent groups for which the user has group membership.

20. The apparatus of claim 19 further comprising:
means for obtaining at the proxy server a set of distinguished names and attributes for group entries that represent groups for which the user has group membership by employing an extended operation within a directory access protocol to request and receive information from a directory server.

21. The apparatus of claim 19 further comprising:
means for obtaining at the proxy server a set of distinguished names and attributes for group entries that represent groups for which the user has group membership from each directory server within the distributed directory environment.

22. The apparatus of claim 19 further comprising:
means for generating, based on responses from multiple directory servers within the distributed directory environment, a compiled set of distinguished names and attributes for group entries that represent groups for which the user has group membership.

23. The apparatus of claim 22 further comprising:
means for sending a second request from the proxy server to a directory server, wherein the second request indicates a directory operation to be performed on behalf of the user, and wherein the second request contains the compiled set of distinguished names and attributes for group entries that represent groups for which the user has group membership.

24. The apparatus of claim 23 further comprising:
means for generating a control that contains the compiled set of distinguished names and attributes for group entries that represent groups for which the user has group membership, wherein the control is formatted in accordance with a directory access protocol; and
means for placing the generated control in the second request.

25. An apparatus for performing a directory operation within a distributed directory environment, wherein the distributed directory environment includes one or more distributed directory servers and a proxy server that acts as an intermediate agent between a client and the distributed directory environment, the apparatus comprising:
means for receiving a first request from a proxy server at a directory server within the distributed directory environment, wherein the first request contains a distinguished name and attributes for a user;
means for evaluating group membership for the user with respect to the distinguished name and attributes for the user and with respect to group entries in a directory information tree that is supported by the directory server; and
means for sending a first response from the directory server to the proxy server, wherein the first response contains a first set of distinguished names and attributes for group entries that represent groups for which the user has group membership.

26. The apparatus of claim 25 further comprising:
means for receiving a second request from a proxy server at a directory server within the distributed directory environment, wherein the second request indicates a directory operation to be performed by the directory server, wherein the second request contains a second set of distinguished names and attributes for group entries that represent groups for which the user has group membership, and wherein the second request contains a distinguished name and attributes for the user.

27. The apparatus of claim 26 further comprising:
means for performing the directory operation with respect to the directory information tree that is supported by the directory server, the distinguished name and attributes for the user, and the second set of distinguished names and attributes for group entries that represent groups for which the user has group membership; and
means for sending a second response from the directory server to the proxy server after performing the directory operation.
